(19) United States
(12) Patent Application Publication
(10) Pub. No.: US 2009/0220700 A1
(43) Pub. Date: Sep. 3, 2009

(54) Coating Composition And Method Of Application

(76) Inventor: Carl Peres, Blackwell, OK (US)

Correspondence Address: LATHROP & GAGE LLP, 2345 GRAND Boulevard, SUITE 2400, KANSAS CITY, MO, 64108, US

(21) Appl. No.: 12/039,202

(22) Filed: Feb. 28, 2008

(51) Int. Cl. C09D 175/04; C08L 75/04; B05D 1/36

(52) U.S. Cl. 427/407.1; 525/452; 525/453

(57) ABSTRACT

A coating composition is provided to improve the integrity of paint coatings applied to a substrate. The composition comprises a polyurethane uniformly mixed with a polysulfide. The disclosed subject matter may be utilized as an aircraft substrate is provided with a primer coating applied. The coating composition is then applied over the primer coating. Lastly, a top paint coating is applied over the coating composition to complete the layering process. The coating composition provides the top paint coat with the ability to flex and deflect when stresses are applied by adverse environmental conditions.

### TECHNICAL FIELD

The disclosed subject matter relates generally to paint coatings of substrates, specifically to coating compositions to increase the durability and longevity of paint top coats, for transport vehicles such as aircraft.

### BACKGROUND

Exterior surfaces of structures are often exposed to environmental conditions that damage the outer paint coat that covers the structure. Such conditions often include exposure to heat, sunlight, scratches and impinged objects such as hailstones. Transportation vehicles that move at high rates of speed often have accelerated wear and degradation of an outer surface coating due to pollutants that are present in the atmosphere and bodies of water. Such vehicles generally include aircraft, boats, automobiles, and other similar modes of transportation. The above mentioned problems are most apparent in the field of aviation, where the leading edges of the surfaces of aircraft, such as helicopters and airplanes, are bombarded with particulate matter as the aircraft travels rapidly through the air. Further, the high altitude levels logged over the life of aircraft expose the exterior surfaces to adverse conditions such as high levels of UV radiation and temperature extremes that cause expansion and contraction of the outer paint layer. All the while, it is desired for such aircraft to maintain their gloss or other decorative aspects.

It is common practice to protect the outer layer of paint on an aircraft from erosion, chipping, or peeling by applying a layer of plastic film or “boot” over the top coat of paint. This layer reduces the stress placed on the top coat layer by absorbing and deflecting matter that is incident to the aircraft. Further, the films typically used in the art, such as adhesively-applied pigmented films, are flexible and adherent to substrates even at very high and low temperatures. These films typically comprise an adhesive layer, a film layer that may optionally be pigmented, and an overlay or protective layer.

However, such films often suffer from the same wear problems as paint coats, and are found to erode, chip, and peel away from exposed surfaces over time. This results in increased maintenance costs for both labor and materials. Furthermore, it is difficult to form the “boot” layer to irregular, non-flat surfaces such as the nosecone or leading edges of wings on an aircraft.

### SUMMARY

The present disclosed subject matter improves on the contemporary state of the art by providing a composition and method for increasing the life span and integrity of exterior coatings on substrates, particularly on aircraft. The composition is applied on a substrate between the base or primer coat and top paint coat to provide a cushioning or flexible layer beneath an exterior coat. This application allows the paint top coat to “flex” and transfer stresses to the composition layer upon exposure to high velocity particulate matter present in the atmosphere, or upon encountering extreme temperature conditions.

The disclosed composition also serves as a bonding agent with strong adhesive properties to both typical primer coatings and typical paint top coatings to ensure that the top coat does not delaminate or separate from the substrate. The disclosed composition may be applied by conventional methods, such as a spray application, to cause minimal interruption or inconvenience when painting or coating an aircraft.

The disclosed composition is a coating composition, and its disclosed methods of application are such that they facilitate greater protection to outer paint coatings on substrates. The coating composition comprises a polyurethane uniformly mixed with a polysulfide. The polyurethane is formed from the reaction of a hydroxyl-containing compound in a first component with an isocyanate compound in a second component. The polysulfide is formed from the reaction of a polysulfide polymer base component with a curing agent, such as manganese dioxide, the curing agent designed to further polymerize the polysulfide polymer. The individual components that make up the polysulfide, and the corresponding components that make up the polyurethane, can be separately combined before admixing the polysulfide and polyurethane together to form the coating composition. Alternatively, the components that react to form the polyurethane and the polysulfide can all be admixed together at the same time, whereby the polyurethane and polysulfide compounds are formed by the above reactions to create the coating composition.

For a substrate on a transportation vehicle, such as a boat, car or aircraft, the coating composition is applied over the primer coat. After curing of the composition, the top or exterior paint coat can applied over the composition. The composition acts as a bonding agent to bind the primer and top paint coatings while providing a flexible undercoat to the top coat. For example, this arrangement may allow the top coat to flex and deflect when the substrate is exposed to high velocity particulate matter, as well as allow the top coat to expand and contract when presented with extreme temperature ranges.

### DETAILED DESCRIPTION

The present disclosed subject matter provides a composition and method for improving the integrity and longevity of an outer coating of paint on a substrate when exposed to adverse environmental conditions. More particularly, the composition comprises a polyurethane, preferably formed from the reaction of a hydroxyl-containing compound with an isocyanate having two or more isocyanate (—NCO) groups, mixed with a polysulfide, preferably formed from the reaction of a liquid polysulfide with a polysulfide curing agent. The coating composition is applied between the primer coating and the top paint coating on a substrate. The present disclosed subject matter provides a coating composition that forms an elastomer-type layer to facilitate flexure of the top paint coat when stresses are applied. Although this application will help protect the outer paint coating on a variety of substrates from damage due to physical conditions in the environment, the present disclosed subject matter is ideally suited for aircraft coating applications.

The polyurethane is a two-part polymerization system that combines specific amounts of a hydroxyl-containing compound in a first component with an isocyanate in a second component. In this embodiment, the hydroxyl-containing compounds include 2-Methoxymethylethoxypropanol, 1-Methoxy-2-Propanol Acetate, and Methoxymethylethoxypropanol Acetate. Likewise, the isocyanate compound is, for example, Hexamethylene Diisocyanate. Additionally, other components can be provided in either the first or second components, such as a carbon black fillers, solvents such as Methyl Ethyl Ketone and Ethyl Acetate, and pigments such as Titanium Dioxide. The weight ratio of diisocyanate compounds to hydroxyl-containing compounds, may for example, range from about 2:1 to about 6:5. The components are thoroughly mixed to form the polyurethane composition.

Likewise, the polysulfide sealant is a two-part polymerization system combining specific amounts of a polysulfide polymer in a base component with a curing agent or oxidant, such as manganese dioxide. The weight ratio of polysulfide polymer to manganese dioxide is about 10:1. The components are thoroughly mixed to form the polysulfide composition. The manganese dioxide serves to further polymerize the polysulfide polymer. Acids, such as stearic acid, can also be provided with the curing agent to affect the cure rate of polysulfide.

Once the polyurethane components and polysulfide components are individually mixed, the two are combined together to form the coating composition of the present disclosed subject matter. Alternatively, the component compounds that react to form the polyurethane and the polysulfide can all be admixed together at the same time, whereby the polyurethane and polysulfide compounds are formed by the above reactions to create the coating composition. The amounts of hydroxyl-containing compound and isocyanate compound that form the polyurethane are ideally combined at stoichiometric ratios for optimal composition properties. However, such ratios do not have to be strictly observed as long as the polyurethane and polysulfide compositions formed provide strong bonding and elastomer-type properties in the coating composition. Also, the ratio of polyurethane composition to polysulfide composition in the present disclosed subject matter does not have to be precisely measured, as long as the coating composition provides the above mentioned properties and has a suitable viscosity to allow for a spray application onto a substrate.

The present disclosed subject matter provides a polyurethane and polysulfide mixture that is functionalized with a number of reactive groups that provide strong interlayer bonding between typical primer coat layers, such as epoxy-based coatings or silane mixtures, and the composition layer, and between typical top paint coat layers, such as polyurethane-based paints, and the composition layer. This bonding provides strong resistance to delamination of layers caused by high-wind velocity and bombardment by particulate matter, as well as by aircraft fuel, deicing fluids and other solvents.

The disclosed subject matter may be applied to an airplane, as the substrate. The airplane substrate is prepared by applying a primer coat layer of an epoxy primer or a silane adhesion promoter to the outer skin of at least a portion of the plane. Generally, the substrate section is made of aircraft-grade aluminum or fiberglass. The nosecone (radome) and leading edges of the plane are ideal locations for an application of the coating composition because they receive the brunt of the physical stresses from environmental conditions when a plane is traveling though the atmosphere. The coating composition of the present disclosed subject matter is then applied to portions of the plane to which the primer coat has been applied. Because the composition has a sufficiently low viscosity, the method of applying the composition is to use a paint spray gun. However, any method known in the art for applying a coating to a substrate can be used, such as by paint brush. Additionally, once the components are combined to form the composition, there is a limited amount of time, usually less than about 2 hours, in which to apply the composition to the substrate. Otherwise, the composition begins to cure and does not maintain the low viscosity properties necessary to apply the coating using a spray gun.

After the composition has been allowed to cure on the substrate at ambient conditions, or at an accelerated rate using a heat source, a top coat of typical aircraft paint, such as a polyurethane coating, is applied over the coating composition. Once the top coat has cured, the process is complete. The airplane now possesses a top coat with an elastomer-type under coating forming a rubber-like cushion. Because of the mechanical properties possessed by the coating composition, the top coat is allowed to deflect upon being struck by physical objects and can undergo increased expansion and contraction without resulting cracking or peeling.

The coating composition can also be used on other substrates, such as automobiles and boats, where the primer and top coat layers are of similar type materials to those used in the aviation industry. Additionally, other coating layers can be used in addition to the primer and top coat layers so long as the top coat layer is applied to the substrate surface above the composition coating layer of the present disclosed subject matter.

### EXAMPLE

A aircraft nosecone made of fiberglass was used for experimentation purposes. A layer of epoxy-based primer, under the trade name of JETGLO Primer by Sherwin Williams Co., Cleveland, Ohio 44115, was applied to the nosecone and allowed to fully dry such that there was no tackiness. Next, a two-part polymerization system, under the trade name JETGLO Polyurethane Coating by Sherwin Williams Co., Cleveland, Ohio 44115, was used to create the polyurethane coating mixture. The components of the mixture are set out in Table 1:

TABLE 1

| | |
|---|---|
| Ingredient | % By Weight |

Part 1

| | |
|---|---|
| Xylene | 2-4 |
| 2-Methoxymethylethoxypropanol | 0-2 |
| Methyl Ethyl Ketone | 0-2 |
| Ethyl Acetate | 8-24 |
| 1-Methoxy-2-Propanol Acetate | 20-30 |
| Methoxymethylethoxypropanol Acetate | 1-2 |
| Titanium Dioxide | 0-35 |
| Carbon Black | 0-2 |

Part 2

| | |
|---|---|
| Ethyl Acetate | 23 |
| N-Butyl Acetate | 37 |
| Hexamethylene Diisocyanate | 0.6 |
| Hexamethylene Diisocyanate Polymer | 40 |

The hydroxyl-containing compound component, Part 1, and diisocyanate containing compound component, Part 2, were mixed at a weight ratio of approximately 1:1. The polysulfide sealant mixture, item numbers CS 3204 Class B and CS 3204 Part B of Flamemaster Corp., Sun Valley, Calif. 91352, was then formed from a two-part polymerization system. The base component of the mixture comprises 65% by weight of liquid polysulfide polymer and the curing agent component comprises 65% by weight of Manganese Dioxide. Other components of the polysulfide sealant mixture are set out in Table 2.

TABLE 2

| | |
|---|---|
| Ingredient | % By Weight |

Part 1

| | |
|---|---|
| Liquid Polysulfide Polymer | 65% |
| Tetramethyl Thiuram Disulfide | Unknown |
| Phenolic Resin | Unknown |
| Titanium Dioxide | Unknown |
| Calcium Carbonate | Unknown |

Part 2

| | |
|---|---|
| Manganese Dioxide | 65 |
| Hydrogenated Terphenyl | Unknown |
| Diphenyl Guanidine | Unknown |
| Stearic Acid | Unknown |

The base component, Part 1, and curing agent component, Part 2, were mixed at a weight ratio of approximately 10:1 base component to curing agent component such that the manganese dioxide served to further polymerize the polysulfide. Then, the polyurethane coating mixture and the polysulfide sealant mixture were uniformly mixed and combined at a ratio by weight of approximately 3.6:1 polyurethane mixture to polysulfide mixture to form the coating composition. A paint spray gun was used to apply the coating composition to the nosecone over the primer layer at ambient temperature ranging from around 60-90 degrees F. Optimal coating properties were achieved with three separate coats of the composition. Each coat was dried at ambient temperature until there was no tackiness before a subsequent layer was applied. Finally, once the layers had cured until there was no tackiness in the top composition layer, a top paint coat with a polyurethane base was applied to the nosecone over the coating composition and allowed to dry. The top coat was then observed to have a slightly “rubbery” or cushioning feel when pressed with a hand.

A jet airplane having the coated nosecone was flown under typical flying conditions above the altitude in which commercial jets fly, approximately 35,000 feet. Observations of the nosecone after such flights indicated that the top paint coat was maintaining its integrity and there was no sign of chipping, peeling, or delaminating of the paint layer, despite the fact that there was no film or “boot” protective layer over the top coat. Further, the coating layers had maintained a slightly cushioning feel to the touch.

The polyurethane and polysulfide mixtures can also be provided with additional compounds mixed therein, such as UV absorbers, antioxidants, plasticizers, fillers, thinners, pigments, and the like, to enhance the performance or utility of the coating composition.

Alternately, the polysulfide sealant mixture used in the Example above may be from the SEMKIT® Package, PR-1422 B-1/2, Model 654 SEMKIT 1422B1/2CA6548K PRC-Standard available from PRC-DeSoto International, Inc., 3330 West Town Point Dr., Kennisaw, Ga. 30144. The aforementioned SEMKIT® Package includes a Part A and a Part B. Part A is formed of Dimethylacetamide; Kaolin; Carbon Black; Sepiolite; and Calcium Dichromate. Part B is formed from Formaldehyde; Methyl Ethyl Keytone; Tolulene; Calcium Carbonate; Red Iron Oxide; Formaldehyde Polymer with 8-Chloro-1-Propene and Phenol, Amorphous Fumed Silica; and Liquid Polysulphide Polymer with Thiol End Groups.

While preferred embodiments of the disclosed subject matter have been described, so as to enable one of skill in the art to practice the disclosed subject matter, the preceding description is intended to be exemplary only. It should not be used to limit the scope of the disclosure, which should be determined by reference to the following claims.

I claim:

1. A coating composition kit having components parts capable of being mixed together to form a coating composition, comprising:
a polyurethane component comprised of two or more isocyanate groups combined with one or more hydroxyl-containing groups; and
a polysulfide component.

2. The coating composition according to claim 1, wherein the polysulfide component is comprised of a liquid polysulfide polymer combined with a curing agent.

3. The coating composition of claim 1, wherein the weight ratio of the two or more isocyanate groups to the one or more hydroxyl-containing groups ranges from about a 2:1 to about a 6:5 mixture.

4. The coating composition of claim 2, wherein the curing agent is manganese dioxide.

5. The coating composition of claim 4, wherein the weight ratio of liquid polysulfide polymer to manganese dioxide is about a 10:1 mixture.

6. The coating composition of claim 1, wherein the weight ratio of polyurethane component to polysulfide component is about a 3.6:1 mixture.

7. A coating composition kit having components parts capable of being mixed together to form a coating composition, comprising:
a first component part comprising two or more isocyanate groups;
a second component part comprising one or more hydroxyl-containing groups;
a third component part comprising a liquid polysulfide polymer; and
a fourth component part comprising a curing agent.

8. The coating composition of claim 7, wherein the weight ratio of the two or more isocyanate groups to the one or more hydroxyl-containing compounds ranges from about a 2:1 to about a 6:5 mixture.

9. The coating composition of claim 7, wherein the curing agent is manganese dioxide.

10. The coating composition of claim 8, wherein the weight ratio of liquid polysulfide polymer to manganese dioxide is about a 10:1 mixture.

11. The coating composition of claim 7, wherein the ratio by weight of first and second component parts to third and fourth components parts is about a 3.6:1 mixture.

12. A coating composition for application to a substrate comprising:
a polyurethane comprised of the reaction product of two or more isocyanate groups with one or more hydroxyl-containing compounds; and
a polysulfide component.

13. A coating composition disposed on a substrate comprising:
a polyurethane component comprised of the reaction product of two or more isocyanate groups with one or more hydroxyl-containing compounds; and
a polysulfide component.

14. A method of applying a coating composition to a substrate, the method comprising:
uniformly mixing a polyurethane compound with a polysulfide component to form a coating composition; and
applying the coating composition to a substrate.

15. The method according to claim 13, further comprising:
mixing a composition of a first component comprising a hydroxyl-containing compound with a second component comprising an isocyanate to form the polyurethane compound;
mixing a composition of a third component comprising a liquid polysulfide polymer with a fourth component comprising a curing agent to form the polysulfide compound;

16. The method according to claim 13, further comprising:
a first step of applying a primer coating to the substrate before the coating composition is applied to the substrate; and
a final step of applying a top coating of paint to the substrate over at least a portion of the coating composition;
wherein the step of applying the coating composition to a substrate requires the coating composition to be applied over at least a portion of the primer coating.

17. The method according to claim 13, wherein the substrate is an aircraft substrate.
